(19) United States
(12) Patent Application Publication
(10) Pub. No.: US 2012/0087968 A1
(43) Pub. Date: Apr. 12, 2012

(54) Antimicrobial Packaging Material and Methods of Making and Using the Same

(75) Inventor: Cynthia L. Ebner, Greer, SC (US)

(73) Assignee: CRYOVAC, INC., Duncan, SC (US)

(21) Appl. No.: 12/899,678

(22) Filed: Oct. 7, 2010

(51) Int. Cl. A01N 37/12; D01F 1/10; A23B 4/18; A01N 25/34; A01P 1/00

(52) U.S. Cl. 424/412; 514/551; 426/129; 264/211

(57) ABSTRACT

The presently disclosed subject matter is generally directed to packaging materials comprising at least one antimicrobial agent. Particularly, the disclosed packaging materials incorporate, via extrusion into the sealant layer, an antimicrobial agent based on the lauroyl arginate (LAE) moiety. Such packaging materials are suitable for use in the packaging of food products (such as fresh red meat) to control microbial contamination.

### TECHNICAL FIELD

The presently disclosed subject matter relates to antimicrobial packaging materials (such as films) useful in the packaging of foodstuffs and other products. The presently disclosed subject matter also relates to processes for the production of such materials, and to the use of the materials in antimicrobial applications.

### BACKGROUND

During processing, preparation, and packaging, food products can encounter microorganisms that make the food unsuitable for consumption. The microorganisms can originate from the food itself, the food contact surfaces, and/or the surrounding environment. To this end, the safety of food products has been a subject of increasing concern as a result of several well-publicized outbreaks of food-borne pathogens in fresh and ready-to-eat foods. In the United States, food-borne illness affects about 6 to 80 million people per year, causing 9,000 deaths and an estimated cost of 5 billion dollars. It is therefore critical for food products to be processed, handled, and packaged in the safest manner possible to help reduce microbial contamination.

The food industry has responded in various ways in an attempt to reduce microbial contamination. For example, aseptic packaging, pre-fill sterilization, and post-fill sterilization are commonly applied as possible microbial control methods. However, these methods often result in undesirable changes in food quality characteristics. In addition, fresh and minimally processed foods often cannot be preserved by such approaches and must rely on other methods.

Modified atmosphere packaging is another common strategy used by the food industry to extend the shelf life of food products, particularly fresh produce and/or meat. In modified atmosphere packaging, the rate of food deterioration is reduced by modifying the initial concentrations of oxygen and carbon dioxide inside the package. However, the modified gas concentrations change over time. Also, the absence of oxygen can affect freshness and flavor perception as well as encourage the growth of harmful anaerobic microorganisms.

The food industry has also attempted to incorporate antimicrobial agents directly in the food (e.g., preservatives such as BHT) as a means to control contamination. However, antimicrobial agents in or on foodstuffs are usually not acceptable to consumers, as they prefer natural foods and food components. Such additives can also accumulate above safe levels and affect color, flavor, and/or smell of the food product. In addition, it is difficult to formulate a composition that is effective at reducing microorganisms using ingredients that are acceptable for direct food contact according to government regulations.

In addition, prior attempts have been made to incorporate anti-microbial agents into or onto the packaging material surrounding the food item. In general, such attempts have been problematic. Particularly, anti-microbial agents are commonly rendered ineffective as a result of the high processing temperatures used to process typical packaging films or structures. In addition, anti-microbial agents can become immobilized within the polymer network of a film layer, reducing availability on the film surface.

Accordingly, there is a need in the art for improved products and methods to control microbial contamination.

### SUMMARY

In some embodiments, the presently disclosed subject matter is directed to an antimicrobial polymeric film comprising a sealant layer comprising a polymeric substrate and a lauroyl arginate moiety. In some embodiments, the lauroyl arginate moiety is present in the sealant layer in an amount of from about 0.01% to about 20% by weight of the layer.

In some embodiments, the presently disclosed subject matter is directed to a packaged product comprising a product and an antimicrobial polymeric film at least partially surrounding the product. In some embodiments, the antimicrobial film comprises a sealant layer comprising a polymeric substrate and a lauroyl arginate moiety. Particularly, the lauroyl arginate moiety is present in the sealant layer in an amount of from about 0.01% to about 20% by weight of the layer.

In some embodiments, the presently disclosed subject matter is directed to a method of making an antimicrobial polymeric film. Specifically, the method comprises extruding a blend of polymeric substrate and a lauroyl arginate moiety through a slot die or through an annular die to form an extrudate. The extrudate is either cast onto a chilled roller such that the extrudate cools to form a cast film, or the extrudate is oriented as it cools and solidifies such that a film is formed. The lauroyl arginate moiety is present in the sealant layer in an amount of from about 0.01% to about 20% by weight of the layer.

In some embodiments, the presently disclosed subject matter is directed to a method of reducing the microbial contamination of a packaged product. Particularly, the method comprises providing an antimicrobial polymeric film wherein the film comprises a sealant layer comprising a polymeric substrate and a lauroyl arginate moiety. The product is packaged in the antimicrobial polymeric film. The lauroyl arginate moiety is present in the sealant layer of the polymeric film in an amount of from about 0.01% to about 20% by weight of the layer.

### BRIEF DESCRIPTION OF THE DRAWINGS

FIG. 1 is a bar graph illustrating the aerobe log CFU of sterile broth, E. coli culture at 0, 24, 48 hours, and E. coli culture after the addition of LAE HCl and LAE monolaurate.

### DETAILED DESCRIPTION

### I. General Considerations

The presently disclosed subject matter is generally directed to packaging materials comprising at least one antimicrobial agent. Particularly, the disclosed packaging materials incorporate, via extrusion into the sealant layer, an antimicrobial agent based on the lauroyl arginate (“LAE”) moiety. Such packaging materials are suitable for use in the packaging of food products (such as fresh red meat) to control microbial contamination.

### II. Definitions

While the following terms are believed to be understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” can refer to “one or more” when used in the subject specification, including the claims. Thus, for example, reference to “a film” can include a plurality of such films, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed materials and methods.

As used herein, the term “abuse layer” can refer to an outer film layer and/or an inner film layer, so long as the film layer serves to resist abrasion, puncture, and other potential causes of reduction of package integrity, as well as potential causes of reduction of package appearance quality. Abuse layers can comprise any polymer, so long as the polymer contributes to achieving an integrity goal and/or an appearance goal. In some embodiments, the abuse layer can comprise polyamide, ethylene/propylene copolymer, and/or combinations thereof.

As used herein, the term “antimicrobial” refers to microbicidal activity or microbe growth inhibition in a microbe population. In some embodiments, the term “anti-microbial” can refer to a greater than 1 log reduction; in some embodiments, a greater than 2 log reduction; in some embodiments, a greater than 3 log reduction; and in some embodiments, a greater than 4 log reduction in the growth of a population of microbes relative to a control.

As used herein, the terms “barrier” and/or “barrier layer” can refer to the ability of a film or film layer to serve as a barrier to one or more gases. For example, oxygen barrier layers can comprise, but are not limited to, ethylene/vinyl alcohol copolymer, polyvinyl chloride, polyvinylidene chloride, polyamide, polyester, polyacrylonitrile, and the like, as known to those of ordinary skill in the art.

As used herein, the term “bulk layer” can refer to any layer of a film that is present for the purpose of increasing the abuse-resistance, toughness, and/or modulus of a film. In some embodiments, bulk layers can comprise polyolefin, ethylene/alpha-olefin copolymer, ethylene/alpha-olefin copolymer plastomer, low density polyethylene, linear low density polyethylene, and combinations thereof.

As used herein, the term “coextrusion” refers to the process of extruding two or more materials through a single die with two or more orifices arranged so that the extrudates merge and weld together into a laminar structure before chilling, i.e., quenching. Coextrusion can be employed in film blowing, free film extrusion, and extrusion coating processes.

As used herein, the term “copolymer” can refer to polymers formed by the polymerization reaction of at least two different monomers. For example, the term “copolymer” can include the copolymerization reaction product of ethylene and an alpha-olefin, such as 1-hexene. However, in some embodiments the term “copolymer” can include, for example, the copolymerization of a mixture of ethylene, propylene, 1-hexene, and 1-octene.

As used herein, the terms “core” and “core layer” can refer to any internal film layer that has a primary function other than serving as an adhesive or compatibilizer for adhering two layers to one another. In some embodiments, the core layer or layers provide a multilayer film with a desired quality, such as level of strength, modulus, optics, added abuse resistance, and/or specific impermeability.

As used herein, the term “extrusion” is used with reference to the process of forming continuous shapes by forcing a molten plastic material through a die, followed by cooling or chemical hardening. Immediately prior to extrusion through the die, the polymeric material is fed into a rotating screw of variable pitch, i.e., an extruder, that forces the polymeric material through the die.

As used herein, the term “film” can include, but is not limited to, a laminate, sheet, web, coating, and/or the like, that can be used to package a product. The film can be a rigid, semi-rigid, or flexible product. In some embodiments, the disclosed film is produced as a fully coextruded film, i.e., all layers of the film emerging from a single die at the same time. In some embodiments, the film is made using a flat cast film production process or a round cast film production process. Alternatively, the film can be made using a blown film process in some embodiments.

As used herein, the terms “heat shrink” and “heat-shrinkable” refer to the tendency of a film to shrink upon the application of heat such that the size (area) of the film decreases while the film is in an unrestrained state. Likewise, the tension of a heat-shrinkable film increases upon the application of heat if the film is restrained from shrinking.

The term “kill rate” as used herein refers to the number of microorganisms over time that the disclosed antimicrobial film can effectively kill or inactivate.

As used herein, the term “LAE” refers to lauroyl arginate.

As used herein, the term “LAE HCl” refers to ethyl lauroyl arginate hydrochloride salt.

As used herein, the term “machine direction” (“MD”), refers to a direction along the length of the film, i.e., in the direction of the film as the film is formed during extrusion.

The term “meat” refers to any myoglobin-containing or hemoglobin-containing tissue from an animal, such as beef, pork, veal, lamb, mutton, chicken or turkey; and game such as venison, quail, and duck. The meat can be in a variety of forms including primal cuts, subprimal cuts, and/or retail cuts as well as ground, comminuted, or mixed. The meat or meat product is preferably fresh, raw, uncooked meat, but can also be frozen, hard chilled, or thawed. In some embodiments, the meat can be subjected to other irradiative, biological, chemical and/or physical treatments. The suitability of any particular such treatment can be determined without undue experimentation in view of the present disclosure.

As used herein, the term “microbe” or “microorganism” refers to any organism capable of contaminating meat, food, or other products, thereby making such product unsuitable or unhealthy for human or animal consumption or contact. For example, in some embodiments, microbes can include bacteria, fungi, yeasts, algae, molds, mycoplasmids, protozoa, viruses, and the like.

As used herein, the term “moiety” refers to a specific segment or functional group of a molecule. In some embodiments, the term “moiety” can include derivatives.

As used herein, the term “multilayer film” can refer to a thermoplastic film having one or more layers formed from polymeric or other materials that are bonded together by any conventional or suitable method, including one or more of the following methods: coextrusion, extrusion coating, lamination, vapor deposition coating, solvent coating, emulsion coating, or suspension coating.

The term “oriented” as used herein refers to a polymer-containing material that has been stretched at the softening temperature but below the melting temperature, followed by being “set” in the stretched configuration by cooling the material while substantially retaining the stretched dimensions. Upon subsequently heating unrestrained, unannealed, oriented polymer-containing material to its orientation temperature, heat shrinkage is produced almost to the original unstretched, i.e., pre-oriented dimensions.

As used herein, the term “oxygen-impermeable,” or “barrier” and the phrase “oxygen-impermeable layer” or “barrier layer,” as applied to films and/or layers, is used with reference to the ability of a film or layer to serve as a barrier to one or more gases (i.e., gaseous O₂). Such barrier materials can include (but are not limited to) ethylene/vinyl alcohol copolymer, polyvinyl alcohol homopolymer, polyvinyl chloride, homopolymer and copolymers of polyvinylidene chloride, polyalkylene carbonate, polyamide, polyethylene naphthalate, polyester, polyacrylonitrile, homopolymer and copolymers, liquid crystal polymer, SiOx, carbon, metal, metal oxide, and the like, as known to those of ordinary skill in the art. In some embodiments, the oxygen-impermeable film or layer has an oxygen transmission rate of no more than 100 cc O₂/m²·da·atm; in some embodiments, less than 50 cc O₂/m²·da·atm; in some embodiments, less than 25 cc O₂/m²·da·atm; in some embodiments, less than 10 cc O₂/m²·da·atm; in some embodiments, less than 5 cc O₂/m²·da·atm; and in some embodiments, less than 1 cc O₂/m²·da·atm (tested at 1 mil thick and at 25° C. in accordance with ASTM D3985, herein incorporated by reference in its entirety).

As used herein, the term “oxygen-permeable” as applied to films and/or film layers refers to a film packaging material that can permit the transfer of oxygen from the exterior of the film (i.e., the side of the film not in contact with the packaged product) to the interior of the film (i.e., the side of the film in contact with the packaged product). In some embodiments, “oxygen-permeable” can refer to films or layers that have a gas (e.g., oxygen) transmission rate of at least about 1,000 cc/m²/24 hrs/atm at 73° F.; in some embodiments, at least about 5,000 cc/m²/24 hrs/atm at 73° F.; in some embodiments, at least about 10,000 cc/m²/24 hrs/atm at 73° F.; in some embodiments, at least about 50,000 cc/m²/24 hrs/atm at 73° F.; and in some embodiments, at least about 100,000 cc/m²/24 hrs/atm at 73° F. The term “permeable” can also refer to films that do not have high gas permeability, but that are sufficiently permeable to affect a sufficiently rapid bloom for the particular product and particular end-use application.

As used herein, the term “package” refers to packaging materials configured around a product being packaged. In some embodiments, the phrase “packaged product,” as used herein, refers to the combination of a product that is surrounded by a packaging material.

As used herein, the term “polymer” can refer to the product of a polymerization reaction, and can be inclusive of homopolymers, copolymers, terpolymers, and the like. In some embodiments, the layers of a film can consist essentially of a single polymer, or can have still additional polymers together therewith, i.e., blended therewith. The term “polymeric” can be used to describe a polymer-containing material (i.e., a polymeric film).

The term “polymeric substrate” as used herein refers to the polymeric components of a film layer that represent the majority (by weight) of the film. For example, the sealant layer of the disclosed film comprises a polymeric substrate (which can be polyester, polyamide, polystyrene, for example) in addition to a lauroyl arginate moiety.

The term “polyolefin” as used herein refers to any polymerized olefin, which can be linear, branched, cyclic, aliphatic, aromatic, substituted, or unsubstituted. More specifically, included in the term polyolefin are homo-polymers of olefin, co-polymers of olefin, co-polymers of an olefin and a non-olefinic co-monomer co-polymerizable with the olefin, such as vinyl monomers, modified polymers thereof, and the like. Specific examples include polyethylene homopolymer, polypropylene homopolymer, polybutene homopolymer, ethylene-alpha-olefin copolymer, propylene-alpha-olefin copolymer, butene-alpha-olefin copolymer, ethylene-unsaturated ester copolymer, ethylene-unsaturated acid copolymer, (e.g. ethylene-ethyl acrylate copolymer, ethylene-butyl acrylate copolymer, ethylene-methyl acrylate copolymer, ethylene-acrylic acid copolymer, and ethylene-methacrylic acid copolymer), ethylene-vinyl acetate copolymer, ionomer resin, polymethylpentene, etc.

The term “red meat” as used herein refers to any meat or meat product having a red color when freshly cut. Such meat or meat product can include (but is not limited to) beef, pork, veal, lamb, mutton, or products thereof.

As used herein, the term “seal” can refer to any seal of a first region of a film surface to a second region of a film or substrate surface. In some embodiments, the seal can be formed by heating the regions to at least their respective seal initiation temperatures using a heated bar, hot air, infrared radiation, ultrasonic sealing, and the like. In some embodiments, the seal can be formed by an adhesive.

As used herein, the terms “seal layer”, “sealing layer”, “heat seal layer”, and/or “sealant layer” refer to an outer film layer or layers involved in heat sealing of the film to itself, another film layer of the same or another film, and/or another article that is not a film. Heat sealing can be performed by any one or more of a wide variety of manners known to those of ordinary skill in art, including using heat seal technique (e.g., melt-bead sealing, thermal sealing, impulse sealing, ultrasonic sealing, hot air, hot wire, infrared radiation, and the like).

As used herein, the term “tie layer” can refer to any internal film layer having the primary purpose of adhering two layers to one another. In some embodiments, the tie layers can comprise any nonpolar polymer having a polar group grafted thereon, such that the polymer is capable of covalent bonding to polar polymers such as polyamide and ethylene/vinyl alcohol copolymer. In some embodiments, the tie layers can comprise, but are not limited to, modified polyolefin, modified ethylene/vinyl acetate copolymer, and/or homogeneous ethylene/alpha-olefin copolymer.

As used herein, the term “transverse direction” (“TD”) refers to a direction across a film, perpendicular to the machine or longitudinal direction.

All compositional percentages used herein are presented on a “by weight” basis, unless designated otherwise.

### III. The Disclosed Film

III.A. Generally

The presently disclosed subject matter is directed to an antimicrobial packaging film suitable for use in the packaging of products, such as fresh red meat. Specifically, the packaging film incorporates an antimicrobial agent based on a lauroyl arginate (“LAE”) moiety into the sealant layer of the film. As set forth in more detail herein below, the LAE moiety maintains the antimicrobial efficacy of the film without any adverse appearance or organoleptic issues.

The disclosed film can be monolayer or multilayer. To this end, the disclosed film can comprise 1 to 20 layers; in some embodiments, from 2 to 12 layers; in some embodiments, from 2 to 9 layers; and in some embodiments, from 3 to 8 layers. Thus, in some embodiments, the disclosed film can have 1, 2, 3, 4, 5, 6, 7, 8, 9, 10, 11, 12, 13, 14, 15, 16, 17, 18, 19, or 20 layers.

The disclosed film can have any total thickness as long as the film provides the desired properties for the particular packaging operation in which it is to be used. Nevertheless, in some embodiments the disclosed film has a total thickness ranging from about 0.1 mil to about 15 mils; in some embodiments, from about 0.2 mil to about 10 mils; and in some embodiments, from about 0.3 mils to about 5.0 mils.

In some embodiments, the presently disclosed film exhibits a sufficient Young's modulus so as to withstand normal handling and use conditions. In some embodiments, the film has a Young's modulus of at least about 200 MPa; in some embodiments, at least about 230 MPa; in some embodiments, at least about 260 MPa; in some embodiments, at least about 300 Mpa; in some embodiments, at least about 330 MPa; in some embodiments, at least about 360 MPa; and in some embodiments, at least about 400 MPa. As would be apparent those of ordinary skill in the art, Young's modulus is measured in accordance with ASTM D-882, which is hereby incorporated by reference.

III.B. Sealant Layer

As set forth above, the sealant layer of the disclosed film comprises an antimicrobial agent based on the cationic lauroyl arginate moiety. As a result, the disclosed film exhibits an antimicrobial effect, i.e., it is capable of destroying or inhibiting the growth of microorganisms. While not intended to be bound by any theory, the antimicrobial activity of LAE is believed to be due to the cationic surfactant properties of its active ingredient (ethyl-N^{α}-lauroyl-L-arginate). Cationic surfactants are known to disrupt the integrity of cell membranes in a broad spectrum of bacteria, yeasts, and molds.

While any suitable lauroyl arginate derivative can be used, particularly useful lauroyl arginate moieties include (but are not limited to) ethyl n-lauroyl-L-arginate hydrochloride salt (“LAE HCl”) and ethyl n-lauroyl-L-arginate laurate complex (“LAE monolaurate”). In addition, the anionic component can be comprised of anions of numerous organic or inorganic molecules. For example, complexes can be formed from LAE, such as LAE palmitate, LAE stearate, LAE lactate, LAE citrate, LAE oleate, LAE benzoate, LAE acetate, LAE hydrogen sulfate, LAE phosphonate, and the like.

Examples of commercially available LAE moieties include Mirenat®-N (available from Vedeqsa, Inc., New York, N.Y., United States of America) and CytoGuard LA® (available from A&B Ingredients, Fairfield, N.J., United States of America). See, for example, U.S. Patent Application Publication No. 2010/0173993, the entire disclosure of which is hereby incorporated by reference.

Advantageously, the LAE moieties disclosed above have been approved in the United States and Europe for food applications. To this end, the LAE moieties are non-toxic, non-allergenic, and have been determined to be harmless to human and/or animal health. Continuing, the LAE moieties are effective against a broad range of microorganisms without destroying or damaging meat or produce tissues. Importantly, it has been shown that LAE moieties also do not impart any off-tastes, odors, or changes in color. In addition, LAE moieties are stable at a wide range of temperatures, lighting, and environmental conditions and have been shown to be active during the life of the product.

In some embodiments, the LAE moiety is present in the sealant layer of the disclosed film in an amount ranging from about 0.01% to about 20%; in some embodiments, from about 0.5% to about 10%; and in some embodiments, from about 1% to about 5%, based on the total weight of the layer.

In addition to the LAE moiety, the sealant layer comprises one or more substrate polymers. For example, in some embodiments, the seal layer can additionally comprise one or more of the following: very low density polyethylene, high density polyethylene, polyolefins (including homopolymers and copolymers such as, e.g., low density polyethylene, medium density polyethylene, linear low density polyethylene, polypropylene homopolymers and copolymers, and higher homologues), styrene homopolymers and copolymers (such as polystyrene, styrene maleic anhydride copolymer, styrene acrylonitrile copolymer, and acrylonitrile butadiene styrene copolymer), alkene-vinyl carboxylate copolymers (such as, e.g., ethylene-vinyl acetate copolymers), alkene-methacrylic acid copolymers (such as, e.g., ethylene-acrylic acid copolymers), alkene-alkyl methacrylate copolymers (such as ethylene-methyl methacrylate copolymers), alkene-vinyl alcohol copolymers (such as, e.g., ethylene-vinyl alcohol copolymers), alkene-vinyl chloride copolymers (such as, e.g., ethylene-vinyl chloride copolymers), polycarbonates, polyamides, polyurethanes, polysulfones, poly(vinylidene chlorides), poly(vinyl chlorides), ionomers based on alkali metal or zinc salts of alkene-methacrylic acid copolymers, (meth)acrylate homopolymers and copolymers, fluoropolymers, thermoplastic polyesters, and mixtures of any of the foregoing polymers. Thus, in some embodiments, the sealant layer of the disclosed film can comprise blends of a linear low density polyethylene with a very low density polyethylene, ionomers, or blends of various polyamides in addition to the LAE moiety.

In some embodiments, the sealant layer can additionally comprise an antiblock additive, as would be known to those of ordinary skill in the art. For example, suitable antiblock additives can include (but are not limited to): natural silica (such as diatomaceous earth), synthetic silica, glass spheres, acrylic polymer, silicone resin microbeads, zeolites, ceramic particles, and the like. As would be well understood to those of ordinary skill in the art, the amount of antiblock used in the sealant layer can be varied for particular formulations and processing conditions (such as, for example, about 0.5% to about 15% by weight of the antiblock additive used).

III.C. Other Layers

The presently disclosed film can optionally comprise additional layers. Examples of such layers include (but are not limited to) barrier layers, abuse layers, core layers, tie layers, bulk layers, and the like. Those of ordinary skill in the art are aware of the plethora of polymers and polymer blends that can be included in each of the foregoing layers. Regardless of the particular structure of a given multilayer film, it can be used as a packaging material in accordance with the presently disclosed subject matter so long as the sealant layer comprises an LAE moiety, as set forth in more detail herein.

Thus, in some embodiments, the disclosed film can comprise a barrier layer. In some embodiments, the barrier layer contains a low permeance to oxygen (i.e., no more than about 150 cm³/m² atm 24 hours at 25° C. and 0%

Relative Humidity). In some embodiments, the barrier layer can include at least one member selected from the group comprising: EVOH, PVDC, polyethylene carbonate, polyamide, and polyester.

Optionally, the disclosed film can include a core layer that has a primary function other than serving as an adhesive or compatibilizer for adhering two layers to one another. In some embodiments, the core layer or layers provide a multilayer film with a desired quality, such as level of strength, modulus, optics, added abuse resistance, and/or specific impermeability.

In some embodiments, the disclosed film includes at least one tie layer. The composition, number, and thickness of the tie layers are known to those of ordinary skill in the art. Such tie layers can include (but are not limited to) one or more polymers that contain mer units derived from at least one of the following: C₂-C₁₂ alpha-olefin, styrene, amide, ester, and urethane.

Optionally, the disclosed film can include one or more bulk layers to increase the thickness and thereby the abuse-resistance, toughness, modulus, etc. of the overall film structure. In some embodiments, the bulk layer can include (but is not limited to) a polyolefin, such as an ethylene homopolymer or copolymer.

Additionally, in some embodiments, the disclosed film can comprise an abuse layer. In some embodiments, the abuse layer comprises one or more polymers that serve to resist abrasion, puncture, and other potential causes of reduction of package integrity, as well as potential causes of reduction of package appearance quality. Polymers suitable for use in the abuse layer can include (but are not limited to) one or more of the following: polyester, polyamide, polyurethane, polystyrene, and polyolefin.

Various combinations of layers can be used in the formation of a multilayer film in accordance with the presently disclosed subject matter. The following are several non-limiting examples of combinations wherein letters are used to represent film layers: A/B, A/B/A, A/B/C, A/B/D, A/B/E, A/B/C/D, A/B/C/E, A/B/E/E′, A/B/D/E, A/B/D/C, A/B/C/B/A, A/B/C/D/A, A/B/E/B/A, A/B/C/D/E, A/B/C/E/D, A/B/D/C/D, A/B/D/C/E, A/B/D/E/C, A/B/D/E/E′, A/B/E/C/E, A/B/E/C/D, A/B/E/D/D′, A/B/E/D/E, wherein A represents a sealant layer; B represents a bulk layer or a sealant layer (depending on whether it is present as an inner or outer layer of the film); C represents a barrier layer; D and D′ represent bulk and/or abuse layers (depending on whether they are present as an inner or outer layer of the film); and E and E′ represent abuse layers. Of course, one or more tie layers (“T”) can be used between any one or more layers of in any of the above multilayer film structures.

Regardless of the structure of the disclosed film, one or more conventional packaging film additives can be included therein. Examples of additives that can be incorporated include (but are not limited to): antiblocking agents, antifogging agents, slip agents, colorants, flavorants, meat preservatives, stabilizers, antioxidants, UV absorbers, cross-linking enhancers, cross-linking inhibitors, and the like, as would be well understood to those of ordinary skill in the art.

### IV. Methods of Making the Disclosed Film

The presently disclosed film can be constructed using any of a wide variety of conventional techniques well-known in the art. For example, in some embodiments, the film can be produced using a hot blown process wherein the film is extruded through an annular die and immediately blown to a desired diameter that results in a desired film thickness while the polymer is at or near its melt temperature. Such hot blown films are not considered to be heat-shrinkable because the amount of heat-shrinkability is not high enough to provide the shrink character typically required of heat-shrinkable films. Although hot blown films are oriented, the orientation occurs in the molten state, without producing the orientation-induced stress that renders the film heat-shrinkable.

Alternatively, in some embodiments, the disclosed film can be constructed using a cast process. Particularly, the film can be cast from a slot die with the extrudate being quenched by immediately contacting a chilled roll, resulting in solidification and cooling, followed by being reheated to a temperature below the melt point (preferably to the softening point of the polymer), followed by solid-state orientation using a tenter frame. Alternatively, the film can be formed by downward casting from an annular die, with the resulting annular “tape” being quenched using cascading water, cooled air (or other gas), or even ambient air. The resulting solidified and cooled annular tape is then reheated to a desired orientation temperature and oriented while in the solid state, using a trapped bubble.

Where the film comprises more than one layer, preparation of the film can be effected by coextrusion. Particularly, the film can be prepared by the simultaneous coextrusion of the respective film-forming layers through independent orifices of a multi-orifice die, and thereafter uniting the still molten layers. Alternatively, the film can be prepared by a single-channel coextrusion in which molten streams of the respective polymers are first united within a channel leading to a die manifold, and thereafter extruded together from the die orifice under conditions of streamline flow without intermixing thereby to produce a multi-layer polymeric film that can be oriented and heat-set. In addition, formation of a multi-layer film can also be effected by conventional lamination techniques, such as by laminating together a preformed first layer and a preformed second layer, or by casting the first layer onto a preformed second layer.

Optionally, the disclosed film can be sequentially or biaxially oriented. Particularly, orienting involves initially cooling an extruded film to a solid state (by, for example, cascading water or chilled air quenching) followed by reheating the film to within its orientation temperature range and stretching it. The stretching step can be accomplished in many ways such as by, for example, “blown bubble” or “tenter framing” techniques, both of which are well known to those skilled in the art. After being heated and stretched, the film is quenched rapidly while being maintained in its stretched configuration so as to set or lock in the oriented molecular configuration. An oriented film can be annealed to reduce or completely eliminate free shrink in one or more directions.

In some embodiments, if the film is oriented, it is subsequently annealed or heat set. That is, following orientation and cooling, the film can be reheated to or near its orientation temperature (either in a constrained or nonconstrained configuration) to dimensionally stabilize the film and to impart desirable mechanical properties.

In some embodiments, the disclosed film can be partially or wholly cross-linked. To produce cross-linking, an extrudate can be treated with a suitable radiation dosage of high-energy electrons (using an electron accelerator, Van der Graaf generator, and/or a resonating transformer) with the dosage level determined by standard dosimetry methods. One of ordinary skill in the art would understand that the radiation is not limited to electrons from an accelerator since any ionizing radiation can be used. In some embodiments, a suitable radiation dosage of high energy electrons can be about 10 to about 140 kGreys; in some embodiments, from about 20 to about 100 kGreys; and in some embodiments, from about 30 to about 80 kGreys.

In some embodiments, the disclosed film can be heat-shrinkable. The shrinkage characteristics of a film are determined by the stretch ratios and heat-setting conditions employed during its manufacture, as is well known in the art. In general, the shrinkage behavior of a film that has not been heat-set corresponds to the degree to which the film has been stretched during its manufacture. In the absence of heat-setting, a film that has been stretched to a high degree will exhibit a high degree of shrinkage when subsequently exposed to heat; a film which has only been stretched by a small amount will only exhibit a small amount of shrinkage. Heat-setting has the effect of providing dimensional stability to a stretched film, and “locking” the film in its stretched state. Thus, the shrinkage behavior of a film under the action of heat depends on whether, and to what extent, the film was heat-set after the stretching operation(s) effected during its manufacture.

In some embodiments, the disclosed film can be printed. In the simplest cases, the disclosed film can be printed using black letters with the product identification and the instructions for correct product storage or use. Alternatively, in the most complex cases, the disclosed film can comprise designs of various colors, product advertising, and/or production information. To improve print adhesion, in some embodiments the disclosed film can be primed using a coating of a resin that improves adhesion, gloss, and/or durability of the print. In some embodiments, the printed surface of the film can be rendered more receptive to ink by subjecting it to a corona discharge treatment or to any other treatment that is known to increase surface energy, such as flame treatment, as would be apparent to those of ordinary skill in the art.

As well known in the art, the LAE materials can vary in physical property from liquids to waxes to hard solids. Accordingly, the LAE material can be added to the sealant layer of the disclosed film using a variety of methods. Particularly, one method is to directly, gravimetrically feed the LAE solid at the desired concentration into the sealant resin extruders using standard blenders and feeders. The LAE material melts in the barrel of the extruder, along with the sealant resin pellets and becomes uniformly distributed into the melt at the desired concentration. Such methods work well in embodiments wherein the LAE material is a hard solid, such as a pellet or powder.

Alternatively, in some embodiments, the LAE material can be added to a side stuffer or other extruder port further down the barrel to limit the total residence time and heat exposure.

Further, in some embodiments, the LAE material can be melted and liquidly injected into the extruder at the desired concentration. Such methods work are beneficial in embodiments wherein the LAE material is soft and/or waxy.

In addition, in some embodiments, a masterbatch of the LAE material can be prepared in a suitable resin at a higher loading level using extrusion techniques such as the three methods disclosed above. The masterbatch is then blended with additional sealant resins. Such a process allows for more precise metering of the additive at very low levels.

### V. Methods of Using the Disclosed Film

The presently disclosed subject matter is directed to an antimicrobial packaging film and articles constructed from the film that exhibit antimicrobial functionality. Particularly, as set forth herein, the disclosed film comprises an antimicrobial agent incorporated into the sealant layer of the film. When the film contacts a packaged product, the antimicrobial agent is thereby used to kill microbial agents.

Thus, it has been discovered that microorganisms on food products can be controlled by packaging the product in a film of the type disclosed herein above (i.e., a film comprising an LAE moiety incorporated into the sealant layer of the film). Thus, when a product is packaged in the disclosed film, the initial contact with the film reduces the number of microorganisms on the surface of the product on contact. In addition, by allowing the film to remain in contact with the product during packaging, the antimicrobial composition can reduce the number of microorganisms on the food product between the initial application and packaging if the food product becomes re-contaminated. As a result, pathogenic or spoilage microorganisms in the product are controlled (i.e., the number of microbes is reduced compared to products packaged in films lacking an antimicrobial agent). For example, in some embodiments, the disclosed film exhibits a log E. coli kill rate of at least 1 log CFU/g.

The products can be packaged in the disclosed film in a variety of ways known to those of skill in the art such that the product is at least partially surrounded by the disclosed film. Thus, in some embodiments, the disclosed film can be packaged using vacuum packaging, shrink wrapping, modified atmosphere packaging, bags, pouches, films, trays, bowls, clam shell packaging, web packaging, and the like. Such methods are well known to those of ordinary skill in the packaging art.

### VI. Products

As set forth in detail herein above, the disclosed film can be used to package a wide variety of foodstuffs, including meat products. In addition, the disclosed films can also be used to provide an antimicrobial surface in a variety of applications, such as in medical environments and equipment and in food packaging. One of ordinary skill in the art would appreciate that the presently disclosed subject matter can be used in accordance with a wide variety of products and thus is not limited to the products set forth above.

### VII. Benefits of the Disclosed Film

As set forth herein above in detail, the disclosed film comprises a sealant layer comprising an LAE moiety incorporated therein. Accordingly, the antimicrobial properties associated with the LAE moiety are integrated within the film. As a result, when the film contacts a product, the antimicrobial agent is thereby used to kill microbial agents. In some embodiments the kill rate of the microbial film is about 90% to about 99.99%. As illustrated below, a kill of 90% to 100% of the microbes is desired, and there can be a change of 0.1 to 4.0 or greater log reduction versus an untreated control (depending on the level of contamination start).

Thus, when the product is a food product, spoilage can be reduced or eliminated. In general, improvements in the spoilage characteristics of food products lead to retention of desirable color, flavor, and nutrients with minimal formation of undesirable compounds. Economic benefits of reduced spoilage include cost reduction related to capital, energy, and packaging material savings, and a longer shelf life.

### EXAMPLES

The following Examples provide illustrative embodiments of the presently disclosed subject matter. In light of the present disclosure and the general level of skill in the art, those of ordinary skill can appreciate that the following Examples are intended to be exemplary only and that numerous changes, modifications, and alterations can be employed without departing from the scope of the presently disclosed subject matter.

Tables 1 and 2 below list resin identification and multilayer film construction information, as follows:

TABLE I
Resin Identification

| Material | ID | Description |
|---|---|---|
| A | AFFINITY PL | Dow Chemical Company (Midland, |
| | 1281G1 | Michigan, United States of America) |
| B | LL 3003.32 | ExxonMobil (Fairfax, Virginia, United |
| | | States of America) |

A is a low density ethylene/octene copolymer having a density of 0.898-0.902 g/cc, 13% octene concentration, and DSC melting point 97-101° C.

B is linear low density ethylene/hexene copolymer having a density of 0.916-0.919 g/cc, 10% hexene concentration, melt index 2.9-3.5 g/10 minutes, and melting point 124° C.

TABLE 2
Monolayer Sealant Film Formulations

| | | Component | Component | Component | |
|---|---|---|---|---|---|
| Film ID | | 1 | 2 | 3 | Total |
| Film 1 | Resin | A | B | LAE | — |
| Control | Volume % | 60 | 40 | 0 | 100 |
| | Micron | | | | 50.8 |
| Film 2 | Resin | A | B | LAE HCl | — |
| | Volume % | 59.4 | 39.6 | 1 | 100 |
| | Micron | | | | 50.8 |
| Film 3 | Resin | A | B | LAE HCl | — |
| | Volume % | 58.2 | 38.8 | 3 | 100 |
| | Micron | | | | 50.8 |
| Film 4 | Resin | A | B | LAE | — |
| | | | | Monolaurate | |
| | Volume % | 59.4 | 39.6 | 1 | 100 |
| | Micron | | | | 50.8 |
| Film 5 | Resin | A | B | LAE | — |
| | | | | Monolaurate | |
| | Volume % | 58.2 | 38.8 | 3 | 100 |
| | Micron | | | | 50.8 |

### Example 1

### Nutrient Broth Study of LAE Materials in Fresh Red Meat Packaging

A culture of Difco nutrient broth (available from Weber Scientific, Hamilton, N.J., United States of America) and E. coli (strain ATCC® 4157™ KWIK STIK™, available from MicroBioLogics, Inc., St. Cloud, Minn., United States of America) was prepared by adding 1 tube of the E. coli to 400 mL of broth medium and incubating overnight at 37° C. 50 mL of the culture was added to each of three 100 mL sterile bottles as set forth in Table 3 below. Particularly, sample 1 was the positive control, sample 2 contained 0.5 g LAE HCl, sample 3 contained 0.5 g LAE monolaurate, and Sample 4 was the negative control.

TABLE 3
Nutrient Broth Bottles

| | mL Sterile | mL Sterile | | |
|---|---|---|---|---|
| | Nutrient Broth + | Nutrient | | (g) LAE |
| Sample # | E. Coli | Broth | (g) LAE HCl | Monolaurate |
| 1 | 50 | — | — | — |
| 2 | 50 | — | 0.5 | — |
| 3 | 50 | — | — | 0.5 |
| 4 | — | 50 | — | — |

Samples 1-4 were incubated at 45° C. and the number of E. coli counts was determined by plating about 1.0 mL of each sample onto aerobic plate count 3M Petrifilm™ plates (available from 3M Microbiology Products, St. Paul, Minn., United States of America) at 0, 24, and 48 hour time points. The experiments were conducted in duplicate.

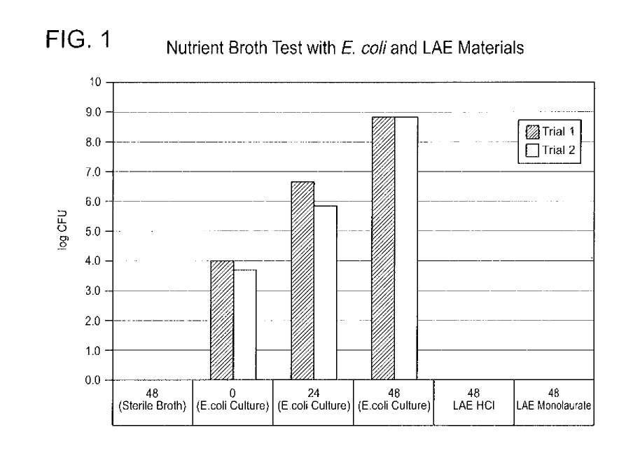

As illustrated in Table 4 and FIG. 1, the positive control (sample 1) increased in the number of bacteria over the 48 hour time period. The samples containing the two LAE agents (samples 2 and 3) showed no growth of bacteria over the 48 hour time period. The negative control (sample 4) showed no growth of bacteria over the 48 hour time period.

TABLE 4
Nutrient Broth Test Results

| | | Aerobe Count Trial 1 | | | | Aerobe Count Trial 2 | | | |
|---|---|---|---|---|---|---|---|---|---|
| — | | | | Mean | | | | Mean | |
| Sample | — | | Log | Log | | | Log | Log | |
| No. | Hrs | CFU/g | CFU/g | CFU/g | SD | CFU/g | CFU/g | CFU/g | SD |
| 1 | 0 | 1.10E+04 | 4.04 | 3.97 | 0.10 | 5.50E+03 | 3.74 | 3.68 | 0.09 |
| 1 | 0 | 8.0E+03 | 3.90 | — | — | 4.10E+03 | 3.61 | — | — |
| 1 | 24 | 4.40E+06 | 6.64 | 6.67 | 0.02 | 6.40E+05 | 5.81 | 5.83 | 0.03 |
| 1 | 24 | 4.70E+06 | 6.66 | — | — | 7.00E+05 | 5.85 | — | — |
| 1 | 48 | 6.60E+08 | 8.82 | 8.82 | 0.00 | 6.60E+08 | 8.82 | 8.82 | 0 |
| 1 | 48 | 6.60E+08 | 8.82 | — | — | 6.60E+08 | 8.82 | — | — |
| 2 | 0 | 1 | 0.00 | 0 | 0 | 1 | 0.00 | 0 | 0 |
| 2 | 0 | 1 | 0.00 | — | — | 1 | 0.00 | — | — |
| 2 | 24 | 1 | 0.00 | 0 | 0 | 1 | 0.00 | 0 | 0 |
| 2 | 24 | 1 | 0.00 | — | — | 1 | 0.00 | — | — |
| 2 | 48 | 1 | 0.00 | 0 | 0 | 1 | 0.00 | 0 | 0 |
| 2 | 48 | 1 | 0.00 | — | — | 1 | 0.00 | — | — |
| 3 | 0 | 1 | 0.00 | 0 | 0 | 1 | 0.00 | 0 | 0 |
| 3 | 0 | 1 | 0.00 | — | — | 1 | 0.00 | — | — |
| 3 | 24 | 1 | 0.00 | 0 | 0 | 1 | 0.00 | 0 | 0 |
| 3 | 24 | 1 | 0.00 | — | — | 1 | 0.00 | — | — |
| 3 | 48 | 1 | 0.00 | 0 | 0 | 1 | 0.00 | 0 | 0 |
| 3 | 48 | 1 | 0.00 | — | — | 1 | 0.00 | — | — |
| 4 | 0 | 1 | 0.00 | 0 | 0 | 1 | 0.00 | 0 | 0 |
| 4 | 0 | 1 | 0.00 | — | — | 1 | 0.00 | — | — |
| 4 | 24 | 1 | 0.00 | 0 | 0 | 1 | 0.00 | 0 | 0 |
| 4 | 24 | 1 | 0.00 | — | — | 1 | 0.00 | — | — |
| 4 | 48 | 1 | 0.00 | 0 | 0 | 1 | 0.00 | 0 | 0 |
| 4 | 48 | 1 | 0.00 | — | — | 1 | 0.00 | — | — |

### Example 2

### Beef Purge Study of LAE Materials

About 30 mL of purge was isolated from two beef tenderloin packages and transferred to three test tubes (10 mL/tube). As set forth in Table 5 below, 0.5 g LAE HCl was added to the purge in sample 5 and 0.5 g LAE monolaurate was added to the purge in sample 6. Sample 7 was the positive control and contained no LAE derivative.

TABLE 5
Beef Purge Samples

| | | | LAE Monolaurate |
|---|---|---|---|
| Sample # | mL Beef Purge | LAE HCl (g) | (g) |
| 5 | 10 | 0.5 | — |
| 6 | 10 | — | 0.5 |
| 7 | 10 | — | — |

The samples were mixed using a vortex mixer and E. coli counts were determined by plating about 1.0 mL on aerobic plate count 3M Petrifilm™ plates for time 0 readings. The test tubes were then stored in a refrigerator (4° C.) and E. coli counts were determined by plating about 1.0 mL on aerobic plate count 3M Petrifilm™ at 24 and 48 hours. As set forth in Table 6, below, both LAE HCl and LAE Monolaurate eliminated over 99% of the microbial contamination at the 24 and 48 hour time points.

TABLE 6
Beef Purge Test Results

| Sample ID | Time (hrs) | Log CFU/g | | | |
|---|---|---|---|---|---|
| — | — | Avg. CFU/g | Mean | SD | % Reduction |
| 5 | 0 | <1.000E+02 | <2.00 | 0.00 | 99.766 |
| 5 | 24 | <1.000E+02 | <2.00 | 0.00 | 99.990 |
| 5 | 48 | <1.000E+02 | <2.00 | 0.00 | 99.999 |
| 6 | 0 | 3.890E+04 | 4.59 | 0.01 | 8.798 |
| 6 | 24 | 8.913E+04 | 4.95 | 0.07 | 90.880 |
| 6 | 48 | 2.818E+03 | 3.45 | 0.21 | 99.960 |
| 7 | 0 | 4.266E+04 | 4.63 | 0.12 | — |
| 7 | 24 | 9.772E+05 | 5.99 | 0.56 | — |
| 7 | 48 | 7.079E+06 | 6.85 | 0.00 | — |

### Example 3

### Antimicrobial Test Plaque Formation

A blend of 60/40 NB (see Table 1) sealant resin (50g) was heated to 150° C. until uniformly melted, about 5 minutes. Either LAE HCl or LAE Monolaurate was then added to the resin in the desired amount and mixed for about 3 minutes. Each of the blends was removed from the mixer and pressed 2.0 mil plaques were prepared by pressing on a Carver Press, then removed and cooled. The test films were then submitted for antimicrobial analysis. Films were prepared in duplicate to be 1%, 5% LAE HCl (samples 8 and 9, respectively) and 1%, 3%, and 5% LAE monolaurate (samples 10, 11, and 12, respectively). Sample 13 contained no LAE derivative.

### Example 4

### Antimicrobial Film Test

A 1×3 inch tape well on each test film (samples 8-13 prepared in Example 3) was created by cutting a 1×3 inch section from a strip of 3 inch wide vinyl tape and applying the tape to the antimicrobial film surface. The test film was secured to a Lexan® sheet (available from General Electric Company, Fairfield, Conn., United States of America) for stability and handling.

0.2 mL of beef purge was added to each well. A 1×3 inch strip of non-barrier Cryovac D955 film (available from Sealed Air Corporation, Duncan, S.C., United States of America) was placed over the inoculum to provide complete wetting of the test film with the inoculum and to prevent desiccation of the inoculum. The high OTR properties of the Cryovac D955 film allowed the inoculum trapped between the antimicrobial test film and the D955 film to grow.

Inoculated films were incubated at 40° F. for 5 days in a high humidity containing sealed barrier bag (B620, available from Sealed Air Corporation, Duncan, S.C., United States of America). The inoculum was completely recovered from the well by adding both the inoculum-wetted Cryovac D955 film overlayment to a distilled water test tube and by swabbing the test film surface twice and placing the swab in the same test tube. A total of 1 mL of water was added to the inoculum.

The total aerobic plate count in the purge was enumerated by plating 1.0 inoculum in 3M Petri-Film™ aerobic count plates (available from 3M Microbiology Products, St. Paul, Minn., United States of America).

As set forth in Table 7 below, the 1% LAE monolaurate resulted in >89% reductions in bacterial counts, while the 3% and 5% LAE monolaurate samples achieved the maximum achievable “kill” of the aerobic bacteria. The 1% LAE HCl resulted in >50% reductions in bacterial counts, while the 5% LAE HCl showed some variability in performance, but resulted in an average of >85% reductions.

TABLE 7
Antimicrobial Activity of Compounded Films

| | | | | % Reduction | |
|---|---|---|---|---|---|
| Sample | Time | | Log | vs. Purge at | Log CFU |
| ID | (days) | Avg. CFU/g | CFU/g | Time 0 | Reduction |
| 8 | 5 | 1.35E+03 | 3.23 | 60.29 | 0.42 |
| 8 | 5 | 1.55E+03 | 3.18 | 55.88 | 0.34 |
| 9 | 5 | 1.00E+02 | <2 | >97.06 | >1.53 |
| 9 | 5 | 4.50E+02 | 2.70 | 85.29 | 0.88 |
| 10 | 5 | 3.50E+02 | 2.60 | 89.71 | 0.99 |
| 10 | 5 | 3.00E+02 | 2.60 | 91.18 | 1.08 |
| 11 | 5 | 1.00E+02 | <2 | >97.06 | >1.53 |
| 11 | 5 | 1.00E+02 | <2 | >97.06 | >1.53 |
| 12 | 5 | 1.00E+02 | <2 | >97.06 | >1.53 |
| 12 | 5 | 1.00E+02 | <2 | >97.06 | >1.53 |
| 13 | 0 | 3.40E+03 | 3.51 | — | — |

### Example 5

### Meat Packaging Trials

LAE HCl and LAE monolaurate were each extruded into monolayer films 2 through 5 (see Table 2) of sealant resin using a Leistritz laboratory extruder (available from American Leistritz Extruder Corporation, Somerville, N.J., United States of America). Loading levels of 1% and 3% of the additives were prepared and tested. It was observed that the monolayer films looked clear and extruded well.

5 boneless beef loins were cut into rectangular test pieces, weighed, and measured. All original meat surfaces were left intact to retain the microbial flora acquired during packaging and handling.

Sample films 1, 2, 3, 4, and 5 (see Table 2) wrapped around the beef loin pieces and each was placed in a B620 barrier bag. The samples were then vacuum packaged and stored at 35° F. for time points of 7, 14, 21, 28, and 42 days.

On each sampling day, microbial analysis for total aerobic bacteria was conducted on each sample. Particularly, the total aerobic plate count in the package was enumerated by plating 1.0 mL inoculum in 3M Petri-Film™ aerobic count plates. As shown in Table 8, the 1% and 3% LAE HCl samples showed 1.67 and 1.26 log reductions in bacterial counts at 42 days, corresponding to 94-98% reductions in bacterial colonies. The LAE monolaurate samples did not appear to be particularly effective in this trial.

TABLE 8
Antimicrobial Activity of Compounded Films Containing LAE Derivatives

| | Log CFU/g | | | | | Day 42 | | Day 42 |
|---|---|---|---|---|---|---|---|---|
| Sample | Day | Day | Day | Day | Day | Log Reduction | Day 42 | % Reduction |
| — | 7 | 14 | 21 | 28 | 42 | vs. Control | CFU/g | vs. Control |
| 2 | 2.31 | 3.68 | 3.97 | 5.32 | 5.57 | 1.67 | 371,282 | 97.9 |
| 3 | 2.25 | 3.68 | 4.36 | 5.82 | 5.98 | 1.26 | 949,602 | 94.5 |
| 4 | 3.13 | 3.85 | 4.77 | 6.32 | 7.00 | 0.24 | 10,014,280 | 42.0 |
| 5 | 2.97 | 4.12 | 5.53 | 6.37 | 7.11 | 0.12 | 13,005,197 | 24.7 |
| 1 | 2.82 | 4.68 | 5.63 | 7.06 | 7.24 | 0.0 | 17,278,687 | 0.0 |

### CONCLUSIONS

The Examples set forth herein demonstrate the effective prevention of a variety of spoilage issues caused by bacteria, yeast, mold, and the like with packaging materials that incorporate an LAE moiety via extrusion into a polymer layer.

What is claimed is:

1. An antimicrobial polymeric film comprising a sealant layer comprising:
a. a polymeric substrate; and
b. a lauroyl arginate moiety,
wherein said lauroyl arginate moiety is present in said sealant layer in an amount of from about 0.01% to about 20% by weight of the layer.

2. The film of claim 1, wherein said polymeric substrate is selected from the group comprising: polyolefin, polyolefin copolymers, polyester, polyamide, polystyrene, and polycarbonate.

3. The film of claim 1, wherein said lauroyl arginate moiety is selected from the group comprising: ethyl lauroyl arginate hydrochloride salt, lauroyl arginate monolaurate, lauroyl arginate palmitate, lauroyl arginate stearate, lauroyl arginate lactate, lauroyl arginate citrate, lauroyl arginate oleate, ethyl lauroyl arginate benzoate, ethyl lauroyl arginate acetate, ethyl lauroyl arginate hydrogen sulfate, ethyl lauroyl arginate phosphonates, and combinations thereof.

4. The film of claim 1, further comprising an oxygen barrier layer.

5. The film of claim 1, wherein said film exhibits a log E. coli kill rate of at least about 1 log CFU/g.

6. The film of claim 1, wherein said film has a thickness of about 0.1 to about 15 mils.

7. A packaged product comprising:
a. a product; and
b. an antimicrobial polymeric film at least partially surrounding said product,
wherein said antimicrobial film comprises a sealant layer comprising a polymeric substrate and a lauroyl arginate moiety, wherein said lauroyl arginate moiety is present in said sealant layer in an amount of from about 0.01% to about 20% by weight of the layer.

8. The packaged product of claim 7, wherein said product is fresh red meat.

9. The packaged product of claim 7, wherein said polymeric substrate is selected from the group comprising: polyolefin, polyolefin copolymers, polyester, polyamide, polystyrene, and polycarbonate.

10. The packaged product of claim 7, wherein said lauroyl arginate moiety is selected from the group comprising: ethyl lauroyl arginate hydrochloride salt, lauroyl arginate monolaurate, lauroyl arginate palmitate, lauroyl arginate stearate, lauroyl arginate lactate, lauroyl arginate citrate, lauroyl arginate oleate, ethyl lauroyl arginate benzoate, ethyl lauroyl arginate acetate, ethyl lauroyl arginate hydrogen sulfate, ethyl lauroyl arginate phosphonate, and combinations thereof.

11. The packaged product of claim 7, wherein said film comprises an oxygen barrier layer.

12. The packaged product of claim 7, wherein said film exhibits a log E. coli kill rate of at least about 1 log CFU/g.

13. The packaged product of claim 7, wherein said film has a thickness of about 0.1 to about 15 mils.

14. A method of making an antimicrobial polymeric film, said method comprising:
a. extruding a blend of polymeric substrate and a lauroyl arginate moiety through a slot die or through an annular die to form an extrudate; and
b. either:
i. casting the extrudate onto a chilled roller that the extrudate cools to form a cast film; or
ii. orienting the extrudate as it cools and solidifies such that a film is formed;
wherein said lauroyl arginate moiety is present in the sealant layer of said film in an amount of about 0.01% to about 20% by weight of the layer.

15. The method of claim 14, wherein said polymeric substrate is selected from the group comprising: polyolefin, polyolefin copolymers, polyester, polyamide, polystyrene, and polycarbonate.

16. The method of claim 14, wherein said lauroyl arginate moiety is selected from the group comprising: ethyl lauroyl arginate hydrochloride salt, lauroyl arginate monolaurate, lauroyl arginate palmitate, lauroyl arginate stearate, lauroyl arginate lactate, lauroyl arginate citrate, lauroyl arginate oleate, ethyl lauroyl arginate benzoate, ethyl lauroyl arginate acetate, ethyl lauroyl arginate hydrogen sulfate, ethyl lauroyl arginate phosphonate, and combinations thereof.

17. The method of claim 14, further comprising an oxygen barrier layer.

18. The method of claim 14, wherein said film exhibits a log E. coli kill rate of at least about 1 log CFU/g.

19. A method of reducing the microbial contamination of a packaged product, said method comprising:
a. providing an antimicrobial polymeric film, said film comprising a sealant layer comprising:
i. a polymeric substrate; and
ii. a lauroyl arginate moiety,
b. packaging said product in said antimicrobial polymeric film,
wherein said lauroyl arginate moiety is present in said sealant layer in an amount of from about 0.01% to about 20% by weight of the layer.

20. The method of claim 19, wherein said polymeric substrate is selected from the group comprising: polyolefin, polyolefin co-polymers, polyester, polyamide, polystyrene, and polycarbonate.

21. The method of claim 19, wherein said lauroyl arginate moiety is selected from the group comprising: ethyl lauroyl arginate hydrochloride salt, lauroyl arginate monolaurate, lauroyl arginate palmitate, lauroyl arginate stearate, lauroyl arginate lactate, lauroyl arginate citrate, lauroyl arginate oleate, ethyl lauroyl arginate benzoate, ethyl lauroyl arginate acetate, ethyl lauroyl arginate hydrogen sulfate, ethyl lauroyl arginate phosphonate, and combinations thereof.

22. The method of claim 19, wherein said film exhibits a log E. coli kill rate of at least about 1 log CFU/g.
